(19) United States
(12) Patent Application Publication
(10) Pub. No.: US 2014/0089564 A1
(43) Pub. Date: Mar. 27, 2014

(54) METHOD OF DATA COLLECTION IN A NON-VOLATILE MEMORY

(71) Applicants: Yi Chun Liu, Hsinchu City (TW); JiunHsien Lu, Hsinchu City (TW)

(72) Inventors: Yi Chun Liu, Hsinchu City (TW); JiunHsien Lu, Hsinchu City (TW)

(73) Assignee: SKYMEDI CORPORATION, Hsinchu City (TW)

(21) Appl. No.: 13/628,651

(22) Filed: Sep. 27, 2012

(51) Int. Cl. G06F 12/02

(52) U.S. Cl. 711/103; 711/E12.008

(57) ABSTRACT

A method of data collection is performed in a non-volatile memory that has a number of blocks and each block has multiple pages. A timestamp is recorded associated with a data written to the non-volatile memory. Some of the written data are moved from a plurality of different pages respectively to a first block according to the timestamps associated with the plurality of written data stored in the plurality of different pages.

### BACKGROUND OF THE INVENTION

1. Field of the Invention

The present invention generally relates to a non-volatile memory, and more particularly to a method of data collection in a non-volatile memory.

2. Description of Related Art

A flash memory is a non-volatile solid state memory device that can be electrically erased and reprogrammed. As shown in FIG. 1, fragmentation commonly occurs in a flash memory, particularly a flash-based solid state drive (SSD) installed with an operation system, when a file system of a host cannot allocate a contiguous space for data, but instead distributes the data over discontiguous spaces with interposed gaps, at which data are formerly deleted or invalided. The fragmentation results in low efficiency in accessing the flash memory.

Flash memories perform read and write operation in units called pages, and perform erase operation in larger units called blocks. As a flash memory does not support on-site overwrite operations, new data need be written to another free page and the original data should be invalidated. In order to write data into the flash memory, a flash translation layer (FTL) is commonly employed between the file system and the flash memory. The FTL translates or maps a logical address from the file system to a physical address in the flash memory. Moreover, a garbage collection scheme is ordinarily applied to migrate the pages storing valid data in a block to be reclaimed to a clean block, followed by erasing the block to be reclaimed.

The conventional garbage collection, however, is not efficient in reclaiming pages primarily because it does not take into consideration the characteristics of data. Accordingly, a need has arisen to propose a novel scheme to efficiently reduce fragmentation of data in a non-volatile memory such as a flash memory.

### SUMMARY OF THE INVENTION

In view of the foregoing, an embodiment of the present invention provides a method of data collection in a non-volatile memory to improve or optimize the performance of reclaiming storage space in the non-volatile memory.

According to one embodiment, a non-volatile memory has a plurality of blocks and each block has a plurality of pages. A timestamp is recorded associated with a data written to the non-volatile memory. A plurality of the written data are moved from a plurality of different pages respectively to a first block according to the timestamps associated with the plurality of written data stored in the plurality of different pages.

### BRIEF DESCRIPTION OF THE DRAWINGS

FIG. 1 shows a schematic diagram illustrating fragmentation in a conventional flash memory;

FIG. 2A shows a schematic diagram illustrating a non-volatile memory according to one embodiment of the present invention;

FIG. 2B exemplifies a detailed memory of FIG. 2A;

FIG. 3 shows a flow diagram demonstrating a method of data collection in a non-volatile memory according to one embodiment of the present invention;

FIG. 4 shows a detailed flow diagram of step 31 in FIG. 3 according to a specific embodiment of the present invention;

FIG. 5 shows five types of data written from the host; and

FIG. 6 shows a detailed flow diagram of step 33 in FIG. 3 according to a specific embodiment of the present invention.

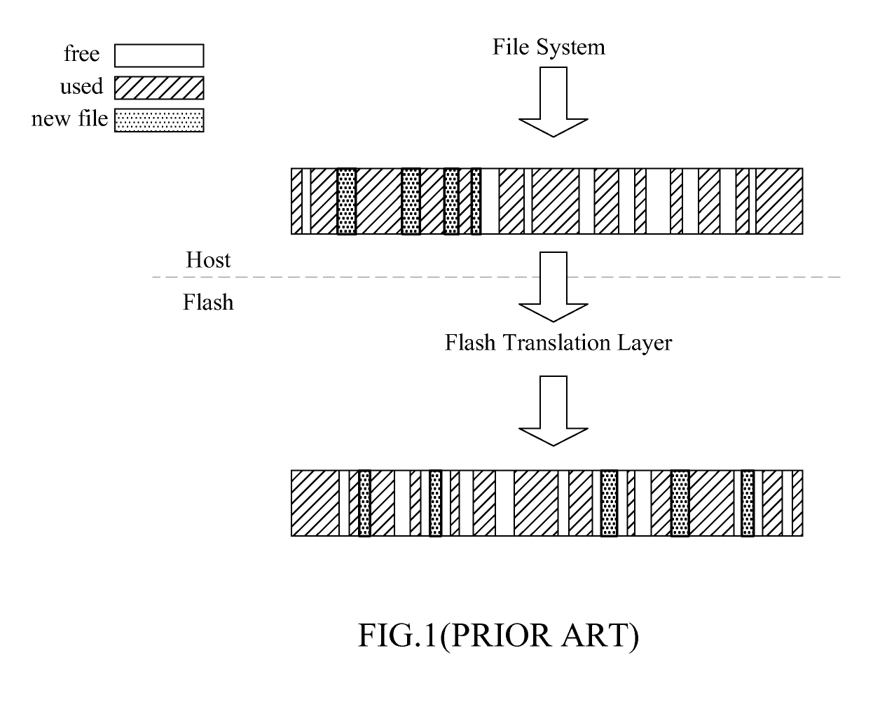

### DETAILED DESCRIPTION OF THE INVENTION

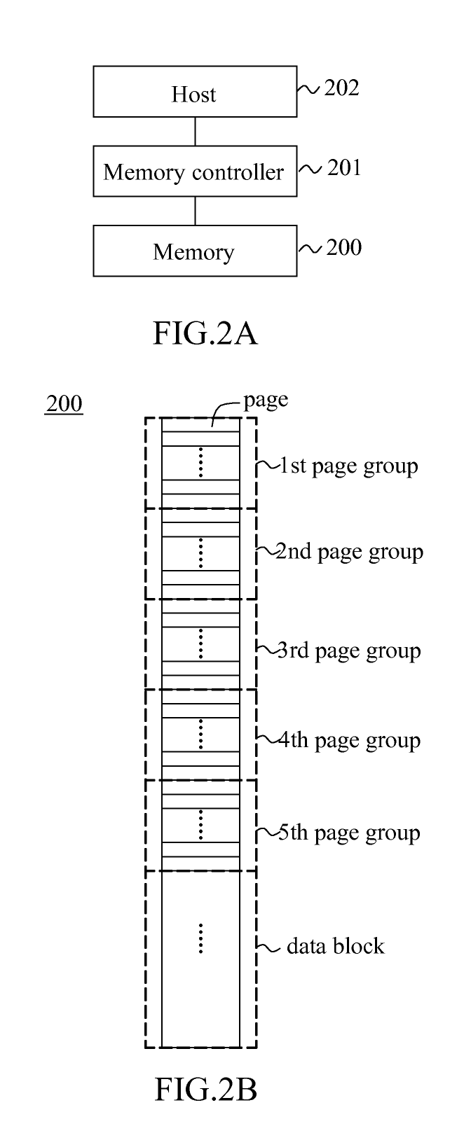

FIG. 2A shows a schematic diagram illustrating a non-volatile memory 200 according to one embodiment of the present invention. The non-volatile memory (abbreviated as memory hereinafter) 200 may be, but not be limited to, a flash memory. In the embodiment, the memory 200 is managed (by a memory controller 201) by page-level mapping in a translation layer (e.g., flash translation layer or FTL) that performs virtual-to-physical address translation or mapping. Although a page-level (e.g., 16 KB) mapping is exemplified in the embodiment, it is appreciated that a cluster-level (e.g., 4 KB) mapping, a sector-level (e.g., 512 B) mapping or other schemes may be used instead.

The memory 200 of the embodiment provides a plurality of pages for storing written data. The plurality of pages may then be configured into a number of page groups that are respectively assigned to store data. Each page group may equal to one block; or alternatively, each page group may include at least one page, for example, in a cluster-level mapping.

In one embodiment, the page groups are assigned to store often-modified small-size data, often-modified large-size data, rarely-modified small-size data, rarely-modified large-size data and valid data in garbage collection (which will described in details later), respectively. The valid data in the garbage collection may, for example, be often-read data. The size of data may be determined by comparing with a predetermined size value. For example, data with a size smaller than or equal to 4 KB are determined as small-size data. In another example, data with a size smaller than or equal to a page size are determined as small-size data.

FIG. 2B exemplifies a detailed memory 200 of FIG. 2A, in which five page groups are provided to stored five types of data mentioned above. Generally speaking, the memory 200 of the embodiment provides at least one page group for storing one type of data.

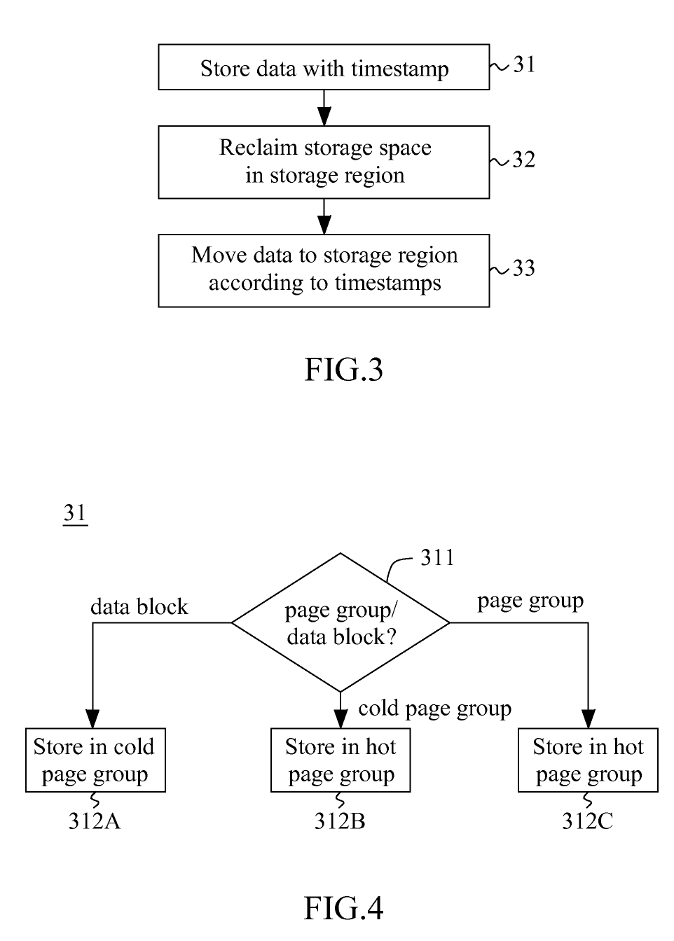

FIG. 3 shows a flow diagram demonstrating a method of data collection in a non-volatile memory 200 according to one embodiment of the present invention. In step 31, a data to be written (from a host 202) to the memory 200 are stored in one of the page groups, and timestamp associated with the written data is recorded. According to one aspect of the embodiment, the timestamp may be used to determine whether data are often modified. In general, data with two successive timestamps being located within a predetermined range are determined as often-modified data or hot data. For example, if a timestamp of formerly written data and a timestamp of currently modified data (update the formerly written data) are within the predetermined range, the data are determined as being hot (often-modified), and should be stored in an associated page group, e.g., hot data page group; otherwise, the data should be stored, for example, in a cold (rarely-modified) data page group. The timestamps mentioned above may be searched, for example, from a table.

As shown in FIG. 2B, in the case that one page group has a size being equal to a data block, the page group may then be used to store corresponding data of the data block. When a page group has insufficient storage space, the memory controller 201 may assign a new page group (e.g., comprising at least one page or block) for storing written, and the original page group with insufficient storage space will act as a data block.

After being operated for a time, the memory 200 may encounter insufficiency in storage space, for example, when free storage space is less than a predetermined value. At that time, the memory 200 will reclaim storage space in a process called garbage collection to relocate valid data and erase invalid data, therefore releasing storage space for storing data.

Subsequently, in step 32, when an amount of free storage space in the memory 200 is below a predetermined value, the memory controller 201 reclaims storage spaces that store invalid data (or executes garbage collection) in memory 200, for example, by relocating valid data and then erasing at least one block. Afterwards, in step 33, valid data in the page group and/or data block are moved to the reclaimed storage space in the data block according to the timestamps associated with the moved valid data such that the valid data having timestamps near or adjacent to each other are allocated in the same data block. For example, among the pages storing valid data to be moved to a free block in the data block, as any two pages that have timestamps near or adjacent to each other are probably interrelated as a same file in the view of the file system, those pages are thus moved to the same data block. Accordingly, those data (when they are invalidated, e.g., deleted in file system) may be subjected to reclaim at the same time in the future, therefore reducing the amount of relocating the pages storing valid data and possibly erasing the whole data blocks without relocating the valid data pages to improve or optimize the performance of the reclaim (e.g., garbage collection).

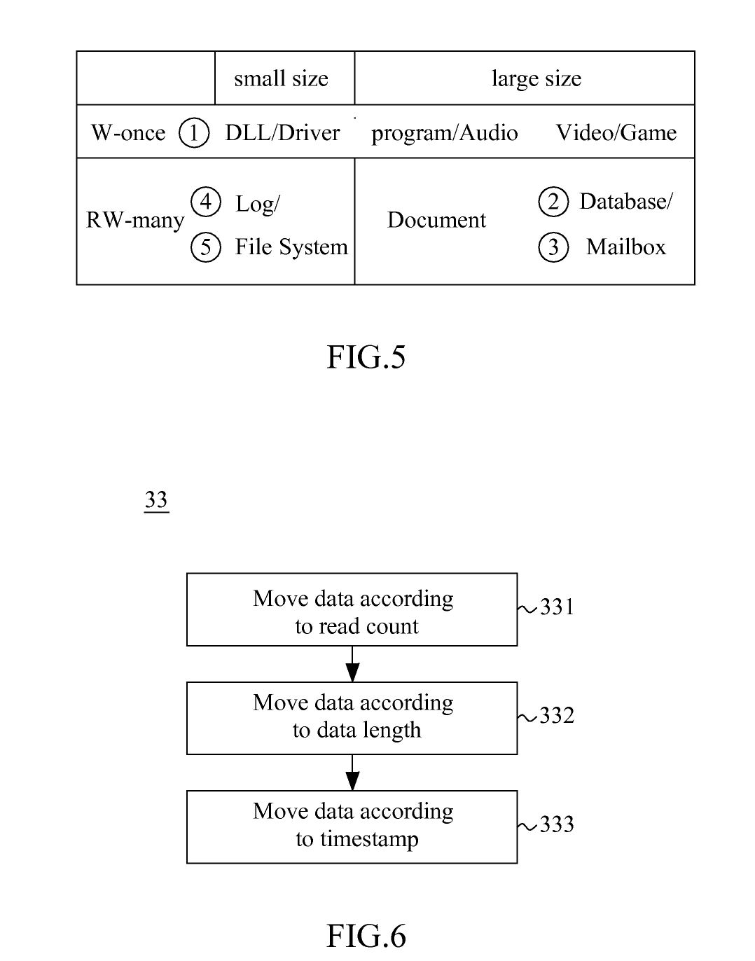

FIG. 4 shows a detailed flow diagram of step 31 in FIG. 3 according to a specific embodiment of the present invention. In the embodiment, as exemplified in FIG. 2B, the memory 200 is configured into at least one page group. According to another aspect of the embodiment, data are determined as being hot when corresponding to-be-modified data exist in the page group; otherwise, the data are determined as being cold. As exemplified in FIG. 5, the data written from the host 202 may be classified into at least five types: (1) rarely-modified (or write-once) data that has since been read (or has a read count) more than predetermined times after it has lately been written to the memory 200; (2) hot large-size data that is large in size (i.e., greater than or equal to a predetermined size), and the corresponding to-be-modified data exist in the page group (i.e., is hot); (3) cold large-size data that is large in size, and the corresponding to-be-modified data not exist in the page group (i.e., is cold); (4) hot small-size data that is small in size (i.e., less than the predetermined size), and the corresponding to-be-modified data exist in the page group; and (5) cold small-size data that is small in size, and the corresponding to-be-modified data not exist in the page group.

As shown in FIG. 4, in step 311, with respect to the written (or modifying) data to be stored in the corresponding page group, it is determined whether a corresponding to-be-modified data (that, for example, has the same logical block address or LBA as the written data) exists in the page group. In a case that corresponding to-be-modified data exist in the data block, the written data are determined as being cold data and are then temporarily stored in the cold data page groups in step 312A. Specifically, the written data are stored in a cold large-size page group or a cold small-size page group according to a size of the written data. In a case that corresponding to-be-modified data exist in the cold data page group, the written data are determined as being hot data and are then temporarily stored in the hot data page group in step 312B. Specifically, the written data are stored in a hot large-size page group or a hot small-size page group according to a size of the written data. In a case that corresponding to-be-modified data exist in the hot data page groups, the written data are determined as being hot data and are then temporarily stored in the hot data page group in step 312C. Specifically, the written data are stored in a hot large-size page group or a hot small-size page group according to a size of the written data. In the embodiment, written data (e.g., type-4 data) having data length less than a predetermined length are collectively stored in the hot small-size data page group to facilitate the performance of step 33 (FIG. 3).

FIG. 6 shows a detailed flow diagram of step 33 in FIG. 3 according to a specific embodiment of the present invention. In step 331, it is optionally performed to move data to the data block according to associated read counts, which are recorded while reading data and are used while moving data. Specifically, data are moved to a data block according to both the read counts associated with the to-be-moved data in the page group and the data in said data block, wherein both the read counts are large than a predetermined value. In step 332, it is optionally performed to move data to the data block according to associated data lengths. Specifically, data are moved to a data block according to both the data lengths associated with the to-be-moved data in the page group and the data in said data block. In step 333, data are moved to the data block according to associated timestamps. Specifically, data are moved to a data block according to both the timestamps associated with the to-be-moved data in the page group and the data in said data block, wherein both the timestamps are near to adjacent to each other. Although read count, data length and timestamp are used in the flow of FIG. 6 to collect valid data, it is appreciated that, in general, at least one of them may be used to collect valid data in order to optimize the performance of reclaiming and release storage space.

In an exemplary embodiment, a plurality of original pages are allocated to provide at least one first page group for storing an original written data, which are then stored with a timestamp associated with the written data. Subsequently, a plurality of new pages are allocated to the first page group for storing a new written data while the plurality of original pages are re-allocated as a second page group. Finally, the original written data stored in the second page group and the new written data stored in the first page group are moved to a third page group according to the timestamps associated with the original and new written data. Moreover, the written data stored in the plurality of second page groups are moved to the third page group according to the timestamps associated with the written data.

In a further embodiment, a read count associated with the written data is recorded. Subsequently, a plurality of the written data are moved to the third page group according to both the read counts associated with the written data in the first page group and the written data in said second page group, wherein both the read counts are greater than a predetermined value.

In a further embodiment, a data length of the written data is determined. A plurality of the written data are moved to the third page group according to both the data lengths associated with the written data in the first page group and the written data in said second page group, wherein both the data lengths are less than a predetermined value.

Although specific embodiments have been illustrated and described, it will be appreciated by those skilled in the art that various modifications may be made without departing from the scope of the present invention, which is intended to be limited solely by the appended claims.

What is claimed is:

1. A method of data collection in a non-volatile memory, the non-volatile memory having a plurality of blocks and each said block having a plurality of pages, the method comprising:
recording a timestamp associated with a data written to the non-volatile memory; and
moving a plurality of the written data from a plurality of different pages respectively to a first block according to the timestamps associated with the plurality of written data stored in the plurality of different pages.

2. The method of claim 1, wherein the non-volatile memory is a flash memory.

3. The method of claim 1, wherein the step of moving the written data is performed during a process of garbage collection.

4. The method of claim 1, in the step of moving the written data, the plurality of written data moved to the first block have the associated timestamps near to or adjacent to each other.

5. The method of claim 4, further comprising:
recording a read count associated with the written data being read from the non-volatile memory; and
moving a plurality of the written data from a plurality of different pages respectively to a second block, the plurality of written data having the associated read counts greater than a predetermined value.

6. A method of data collection in a non-volatile memory, in which the non-volatile memory has a plurality of blocks and each said block has a plurality of pages, the method comprising:
allocating a plurality of original pages to provide at least one first page group for storing an original written data;
storing the original written data with a timestamp associated with the written data;
allocating a plurality of new pages to the first page group for storing a new written data while the plurality of original pages are re-allocated as a second page group; and
moving the written data stored in the plurality of pages to a third page group according to the timestamps associated with the written data.

7. The method of claim 6, wherein the step of storing the written data comprises:
determining whether to-be-updated data corresponding to the written data exist in the first page group, the second page group or the third page group.

8. The method of claim 7, wherein the written data are determined as being cold data when the to-be-updated data exist in the second or third page group; and the written data are determined as being hot data when the to-be-updated data exist in the first page group.

9. The method of claim 6, wherein the step of moving the written data stored in the plurality of pages to a third page group further comprises:
moving the original written data stored in the second page group and the new written data stored in the first page group to the third page group according to the timestamps associated with the original and new written data.

10. The method of claim 9, wherein the step of moving the written data stored in the first page group and the second page group to the third data page group further comprises:
recording a read count associated with the written data; and
moving a plurality of the written data to the third page group according to both the read counts associated with the written data in the first page group and the written data in said second page group, wherein both the read counts are greater than a predetermined value.

11. The method of claim 9, wherein the step of moving the written data stored in the first page group and the second page group to the third page group further comprises:
determining a data length of the written data; and
moving a plurality of the written data to the third page group according to both the data lengths associated with the written data in the first page group and the written data in said second page group, wherein both of the data lengths are less than a predetermined value.

12. The method of claim 6, wherein the step of moving the written data stored in the pages to a third page group further comprises:
moving the written data stored in the plurality of second page groups to the third page group according to the timestamps associated with the written data.

13. The method of claim 6, wherein the third page group is an empty block.

14. The method of claim 6, wherein the sizes of the first page group, the second page group and the third page group each has a size of the block.

15. The method of claim 6, wherein the non-volatile memory is a flash memory.

16. The method of claim 6, wherein the step of moving the written data is performed during a process of garbage collection.
